(19) United States
(12) Patent Application Publication
(10) Pub. No.: US 2026/0001664 A1
(43) Pub. Date: Jan. 1, 2026

(54) SATELLITE THERMAL CONTROL

(71) Applicant: ICEYE OY, Espoo (FI)

(72) Inventors: Patrick Poirot, Helsinki (FI); Charles Smith, Helsinki (FI); Marek Kowaluk, Helsinki (FI)

(21) Appl. No.: 18/879,476

(22) PCT Filed: Jun. 27, 2023
(86) PCT No.: PCT/EP2023/067398

§ 371 Date: Dec. 27, 2024

(30) Foreign Application Priority Data
Jun. 30, 2022 (GB) 2209606.9

(51) Int. Cl. B64G 1/24; B64G 1/10; B64G 1/22; B64G 1/36

(52) U.S. Cl. CPC B64G 1/245; B64G 1/1028; B64G 1/226; B64G 1/36

(57) ABSTRACT

The invention relates to a satellite comprising: a satellite body including at least one radiative surface configured to emit satellite heat to space; and an attitude determination and control ‘ADCS’ system for controlling an orientation of the satellite travelling in orbit around Earth, wherein the ADCS system is configured to change the orientation of the satellite with respect to the sun between a first position in which the radiative surface points away from the sun and a second position in which the radiative surface is exposed to the sun. The invention further relates to a method of controlling thermal radiation heat transfer of a satellite.

The present application relates to spacecraft, and in particular to satellite thermal control.

### BACKGROUND

In spacecraft design, the function of a thermal control system “TCS” is to keep all the spacecraft's component systems within acceptable temperature ranges during all mission phases. All spacecraft components have a range of allowable temperatures that must be maintained to meet operational requirements. If a component is subject to temperatures which are too high or too low, it could be damaged or its performance could be severely affected.

This is particularly challenging for an orbiting satellite since operating in vacuum: air does not balance via convective thermal fluxes between hot spot and cold areas. The satellite experiences extreme temperatures in space due to wide variations in the external environment from extreme coldness in the shadows of deep space or intense heat in the direct sunlight. Further, an orbiting satellite generates heat depending on the power and efficiency of its components.

Temperatures may be regulated with passive and/or active thermal management technology. Passive thermal control aims to maintain component temperatures without using powered equipment. Such systems are typically associated with low cost, volume and weight. Conventional satellite thermal control systems may use a satellite body panel as radiator for dissipating excess heat via radiative heat transfer. However, body panel size increases as thermal control demands increase, and increased body panel size leads to undesirably large satellites. Deployable radiators for dissipating excess heat via radiative heat transfer on small spacecraft can be challenging due to volumetric constraints.

Active thermal control methods rely on input power for operation and are typically more challenging to integrate into small satellites because of the power, mass and volume needs associated with the technology. Accordingly, the use of actively controlled thermal techniques in small spacecraft is limited. However, these methods are typically more effective in maintaining tighter temperature control for components. Typical active thermal devices that may be used on large-scale spacecraft include electrical resistance heaters, cryocoolers, thermoelectric coolers, and fluid loops. For example, thermostatically controlled resistive electric heaters may be used to keep the equipment temperature above its lower limit during a mission's cold phases.

The limitation of some of the known thermal control techniques is that they are not applicable to small spacecraft due to mass, surface area, volume and/or power constraints. A need exist for thermal management systems and methods applicable to small spacecraft.

Some embodiments of the invention described below solve some of these problems. However, the invention is not limited to solutions to these problems and some embodiments of the invention solve other problems.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter.

The invention provides a satellite and a method of controlling thermal radiation heat transfer of a satellite.

In a first aspect, the present disclosure provides a satellite comprising: a satellite body including at least one radiative surface configured to emit satellite heat to space; and an attitude determination and control ‘ADCS’ system for controlling an orientation of the satellite travelling in orbit around Earth, wherein the ADCS system is configured to change the orientation of the satellite with respect to the sun between a first position in which the radiative surface points away from the sun and a second position in which the radiative surface is exposed to the sun.

In some embodiments, the ADCS system is configured to change the orientation of the satellite by rotating the satellite around an axis of rotation extending substantially perpendicular to a travel direction of the satellite.

In some embodiments, a surface normal to the radiative surface extends away from the satellite body in a first direction substantially perpendicular to the axis of rotation.

In some embodiments, in the second position, an angle between the first direction and solar radiation incident on the radiative surface is 90° or less, optionally less than 60°, optionally less than 30°, optionally less than 10°.

In some embodiments, the satellite further comprises one or more temperature sensor(s) for determining a satellite temperature and/or a temperature of one or more components of the satellite, wherein the ADCS system is configured to change the orientation of the satellite in response to a signal from the one or more temperature sensor(s).

In some embodiments, the ADCS system is configured to maintain the satellite in the second position to control a satellite temperature by absorption of incident heat from solar radiation received via the radiative surface.

In some embodiments, the ADCS system is configured to maintain the satellite in the second position for at least 5 minutes, optionally at least 10 minutes, optionally at least 15 minutes.

In some embodiments, the ADCS system is configured to maintain the satellite in the second position until a temperature set point has been reached.

In some embodiments, the ADCS system is configured to maintain the satellite in the first position to control the satellite temperature by emission of satellite heat to space via the radiative surface.

In some embodiments, the radiative surface has a solar absorptivity between 10% and 60%, optionally between 20% and 50%, optionally between 30% and 40%.

In some embodiments, the radiative surface provides an infrared ‘IR’ emissivity of at least 0.85, optionally at least 0.9 and a solar absorptivity of at least 0.3, optionally at least 0.35.

In some embodiments, the radiative surface covers an area of at least 0.05 m², optionally at least 0.1 m², optionally at least 0.15 m².

In some embodiments, the radiative surface comprises part of a radiator panel forming part of an existing structure of the satellite body.

In some embodiments, the radiative surface comprises an adhesive tape comprising a polyvinyl fluoride film.

In some embodiments, the satellite further comprises one or more solar panel(s) attached to the satellite body, wherein a surface normal to a solar surface of the solar panel(s) extends away from the satellite body in a direction substantially opposite to the first direction.

In some embodiments, the ADCS system is configured to control the orientation of the satellite to alternate between the first and second position to selectively provide for heating and cooling of the satellite.

In some embodiments, the satellite further comprises a SAR antenna attached to the satellite body, wherein the SAR antenna faces towards Earth in the first and second position.

In some embodiments, the satellite is a microsatellite, or a small satellite.

In some embodiments, the satellite is an imaging satellite for Earth observation, optionally a SAR satellite.

In a second aspect, the present disclosure provides a method of controlling thermal radiation heat transfer of a satellite, optionally the satellite according to the first aspect, wherein the satellite comprises a satellite body including at least one radiative surface configured to emit satellite heat to space, and an attitude determination and control ‘ADCS’ system for controlling an orientation of the satellite travelling in orbit around Earth, wherein the method performed by the ADCS system comprises: changing the orientation of the satellite with respect to the sun between a first position in which the radiative surface points away from the sun and a second position in which the radiative surface is exposed to the sun.

In some embodiments, changing the orientation of the satellite includes rotating the satellite around an axis of rotation extending substantially perpendicular to a travel direction of the satellite.

In some embodiments, the method further includes maintaining the satellite in the second position to control a satellite temperature by absorption of incident heat from solar radiation received via the radiative surface.

In some embodiments, the method further includes maintaining the satellite in the second position for at least 5 minutes, optionally at least 10 minutes, optionally at least 15 minutes.

In some embodiments, the method further includes maintaining the satellite in the second position until a temperature set point is reached.

In some embodiments, the method further includes maintaining the satellite in the first position to control the satellite temperature by emission of satellite heat to space via the radiative surface.

In some embodiments, the method further includes alternating the orientation of the satellite between the first and second position to selectively provide for heating and cooling of the satellite.

In some embodiments, the method replaces a redundant line of a thermal control system.

In some embodiments, the method is performed between imaging missions.

In some embodiments, the method is performed at a predetermined position in the orbit, a predetermined point in time and/or in response to a measured temperature.

Embodiments of the invention also provide a computer readable medium comprising instructions, for example in the form of an algorithm, which, when implemented in a computing system forming part of a satellite operation system, cause the system to perform any of the methods described therein.

The preferred features may be combined as appropriate, as would be apparent to a skilled person, and may be combined with any of the aspects of the invention. The satellite according to the first aspect can be developed with features that are described in the context of the method of controlling thermal radiation heat transfer according to the second aspect. The method according to the second aspect can be developed further with the features described in the context of the satellite according to the first aspect.

### BRIEF DESCRIPTION OF THE DRAWINGS

Embodiments of the invention will be described, by way of example, with reference to the following drawings, in which:

FIG. 1 is a schematic perspective view of a satellite in orbit above Earth;

FIGS. 2 to 11 show a series of stills of the satellite shown in FIG. 1 at different points in time, wherein the satellite is controlled to provide thermal radiation heat transfer;

FIG. 12 shows is a partial perspective view of a satellite including an ADCS unit for controlling the satellite travelling in orbit around Earth;

FIG. 13 shows photos of a first sample (FIGS. 13a and 13b) and a second sample (FIGS. 13c and 13d) of a radiative surface for which absorptivity and emissivity have been measured as shown in Table 1;

FIG. 14 shows an embodiment of a radiative panel including a radiative surface of the satellite according to FIGS. 1 to 11;

FIG. 15 shows a plot illustrating a temperature profile of a radiative surface; and

FIG. 16 shows a plot illustrating a temperature profile of a few components inside the satellite body.

Common reference numerals are used throughout the figures to indicate similar features.

### DETAILED DESCRIPTION

Embodiments of the present invention are described below by way of example only. These examples represent the best mode of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

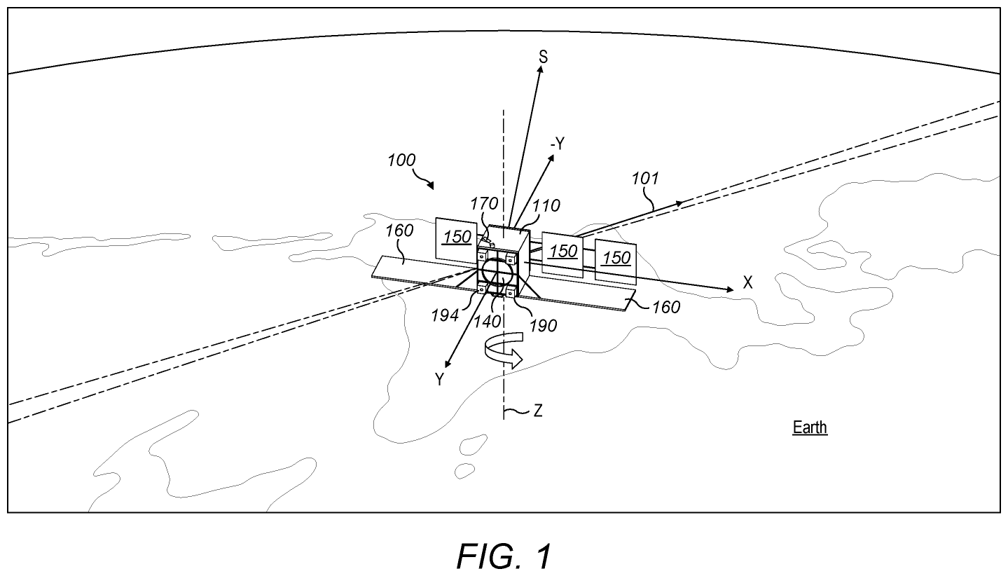

FIG. 1 is a perspective view of a satellite 100 in orbit around Earth. The satellite 100 travels along a direction of travel 101. The satellite 100 shown in FIG. 1 is a micro satellite for Earth observation. However, the present disclosure is equally applicable to other spacecraft, such as small satellites or larger spacecraft. In the following description, for the sake of simplicity, reference is made to a satellite.

In some embodiments, the satellite may be travelling in, or configured to travel in a low Earth orbit. In some embodiments, the satellite 100 may be controlled by a ground segment (not shown in FIG. 1) comprising all the ground-based elements of the spacecraft system. In some embodiments, there is a ground station and/or computing system configured to control the satellite travelling in orbit around Earth and/or to implement some of the operations described here.

As shown in FIG. 1, the satellite 100 comprises a satellite body 110, one or more solar panels 150 and “wings” 160. One or more SAR antennas may be mounted on the satellite wings 160. The satellite additionally comprises a propulsion system 190 shown to be mounted on the satellite body 110 on the surface opposite the solar panels 150. The propulsion system 190 can comprise thrusters, such as four thrusters, one of which is indicated at 194 in FIG. 1, which are part of the system for operating and manoeuvring the satellite to position it appropriately for capturing SAR imagery of the Earth. A computing system may be housed in the satellite body which may be configured to implement some of the operations described herein.

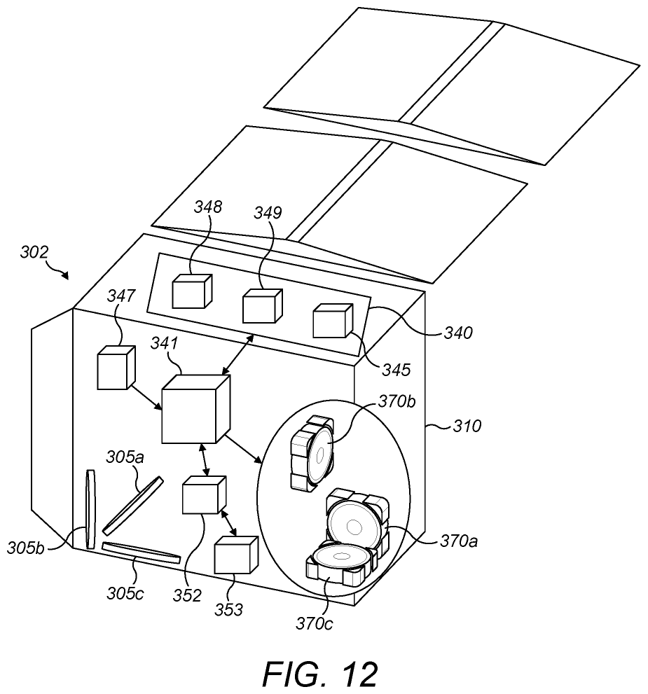

The satellite 100 further comprises an attitude determination and control system “ADCS” unit. The ADCS unit (not shown) is usually located in the satellite body 110. The ADCS unit is used to control the satellite travelling in orbit that is to bring the satellite 100 in a desired orientation and to maintain it. The ADCS unit is further described with reference to FIG. 12. The ADCS unit may be provided with one or more reaction wheels (not shown). The reaction wheel may exert force of torque on the satellite body 110. Additionally or alternatively, the ADCS unit may comprise a plurality of torque rods. The torque rods are generally operated to maintain the satellite 100 in a particular attitude, wherein the operation is controlled by an ADCS controller.

In some embodiments, the satellite 100 includes one or more optical device(s) for measuring the positions of stars using photocells or a camera, such as a star tracker 170 and/or a sun sensor. The star tracker 170 may be mounted on an upper surface of the satellite body 110. The star tracker 170 may be used to determine the orientation of the satellite with respect to the sun. Star trackers normally look into the sky and compare what they see with a built-in catalogue of the sky to determine their orientation with respect to the sun. Two star trackers 170 are used in the embodiment shown in FIG. 1 so that if one of them is blinded by the sun, the other is not. The satellite 100 may also comprise one or more sun sensors (not shown) as a navigational instrument used to detect the position of the sun. Based on the one or more star trackers and/or one or more sun sensors, the satellite can determine the orientation of the satellite with respect to the sun. This information is provided to the ADCS system for controlling the orientation of the satellite 100 to change between the first and second position, as is explained further below.

As shown in FIG. 1, the satellite 100 comprises a radiative surface 140. The radiative surface 140 may be a dedicated surface for dissipating excess heat via radiative heat transfer, sometimes referred to as a radiator. The radiative surface 140 is configured to emit satellite heat to space. This is typically done by emitting infrared “IR” radiation from the surface. The radiative surface 140 shown in FIG. 1 is mainly circular in shape. However, in alternative examples, the radiator surface 140 may be in a different form, such as mainly rectangular in shape. The radiative surface may cover an area of at least 0.05 m², at least 0.1 m², or at least 0.15 m². The round radiative surface 140 shown in FIG. 1 covers an area of approx. 0.2 m² and has a diameter of approx. 0.5 m. Depending on internal temperatures and dissipations, the radiative surface may emit a heating power between 280 W/m² and 480 W/m².

The invention is based on the finding that a satellite's radiator or radiative surface can also be used to absorb incident heat from solar radiation. By adjusting an orientation of the satellite with respect to the sun, the radiator or radiative surface may then be controlled to provide for both heat absorption or heat emission, respectively. To provide for active thermal control, the satellite's ADCS system may be used to change the orientation of the satellite between a first position in which the radiative surface points away from the sun and a second position in which the radiative surface is exposed to the sun. This reduces costs, integration time and number of parts of the satellite, as the ADCS system is integrated in the satellite and no additional components are required to control thermal behaviour. This is particularly advantageous for small spacecraft due to strict mass and volume constraints. For example, if the power requirements are reduced through the use of the ADCS system to control thermal behaviour, this may allow the design of satellite's with smaller solar panels. Additionally or alternatively, the satellite may be designed with one instead of two redundant electrical heating system. Using electricity to reorient the satellite to take advantage of the heat from the sun is less energy-intensive than powering an electric heater.

In some embodiments, the radiative surface 140 and the solar panels 150 are positioned at opposite sides of the satellite body 110. A surface normal to the radiative surface 140 may extend away from the satellite body in a first direction Y. A surface normal to the solar panels 150 may extend away from the satellite body in a direction substantially opposite to the first direction Y. This direction is indicated as −Y in FIG. 1.

During normal operation of the satellite, the solar panels may be continuously oriented toward the sun, whenever possible. Accordingly, the position of the satellite 100 may be controlled such that the solar panels 150 face the sun, as shown in FIG. 1. The direction of the sun is indicted by the arrow labelled “S” in FIG. 1, which may also be referred to as the sun vector. It is well known in the art that a solar panel may capture more energy if it is facing directly at the sun. An exception may be given when the satellite is oriented such that it can perform its intended function, such as imaging of the Earth using synthetic aperture radar ‘SAR’ or other imaging methods. For imaging, the length of a SAR antenna would need to be aligned along the travel direction 101. However, during normal operation of the satellite 100 shown in FIG. 1, the radiative surface 140 would be continuously oriented away from the sun. Accordingly, the satellite 100 is in a position in which the radiative surface 140 faces deep space. The surrounding space environment acts as a heat sink and the radiative surface 140 may be used to reject excess waste heat created on the satellite.

In the first position of the satellite, the radiative surface points away from the sun. In other words, in the first position, a vector normal to the radiative surface extending in the first direction Y points away from the sun. The satellite 100 shown in FIG. 1 is in the first position. The satellite may be in the first position during normal operation. The first position describes a plurality of positions in which the radiative surface is not exposed to the sun. The first position is different from the second position of the satellite, in which the radiative surface is exposed to the sun. In other words, in the second position, the vector normal to the radiative surface points toward the sun. In the second position, the external face of the radiative surface points toward the sun. The second position describes a plurality of positions in which the radiative surface is pointing towards the sun. By changing the orientation of the satellite to the second position in which the radiative surface is exposed to the sun, it is possible to use the radiative surface as a heat source. Changing the orientation of the satellite with respect to the sun may allow implementation of an active thermal control for the satellite via the radiative surface 140.

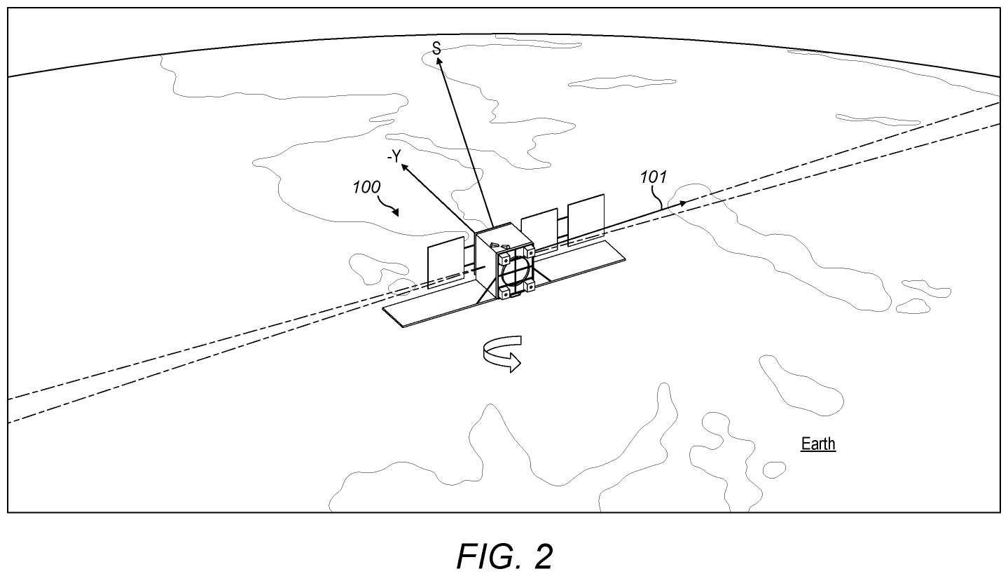

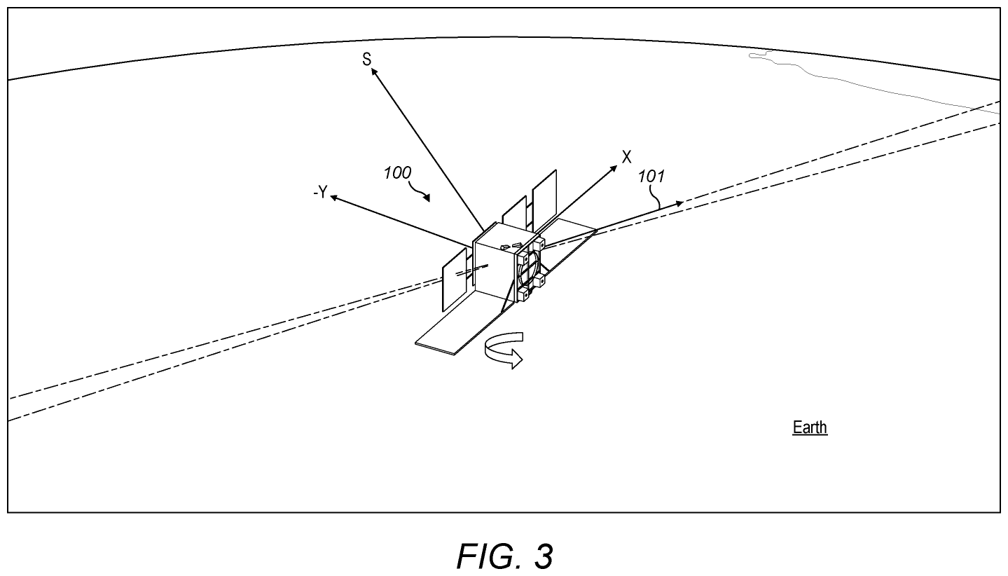

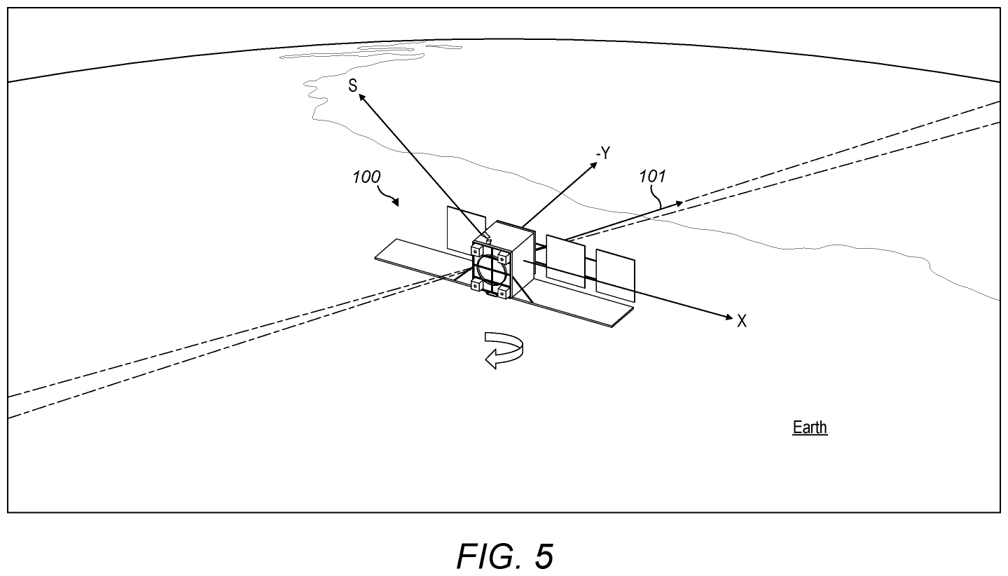

In the following, the sequence of stills shown in FIGS. 1 to 11 is used to illustrate the control of thermal radiation heat transfer of the satellite. During the whole sequence, the satellite travels with a velocity v along the travel direction 101. Further, the ADCS subsystem is configured to change the orientation of the satellite with respect to the sun. In some embodiments, the ADCS system is configured to rotate the satellite along an axis of rotation Z to change and/or maintain the orientation of the satellite with respect to the sun. The axis of rotation Z may run through the satellite body 110. The axis of rotation Z may extend in a direction substantially perpendicular to the first direction Y. The smaller size and greater agility of micro and small satellites facilitates rotation of the entire satellite to change its orientation with respect to the sun.

In this example shown, rotation around the Z axis is chosen because the payload mounted on the wings 160 is a synthetic SAR antenna, which is itself quite sensitive to temperature, particularly hot temperatures, even when the satellite is not imaging. As such, it is best to keep the SAR antenna pointing generally down towards the Earth, even when not imaging, so it receives infrared heating from the Earth and is not exposed directly to the cold of deep space or the extreme heat of direct sunlight. With other examples of different types of satellites and payloads, this may not be a constraint and rotation around an axis other than the Z axis could be chosen to rotate the satellite around to change and/or maintain the orientation of the satellite with respect to the sun.

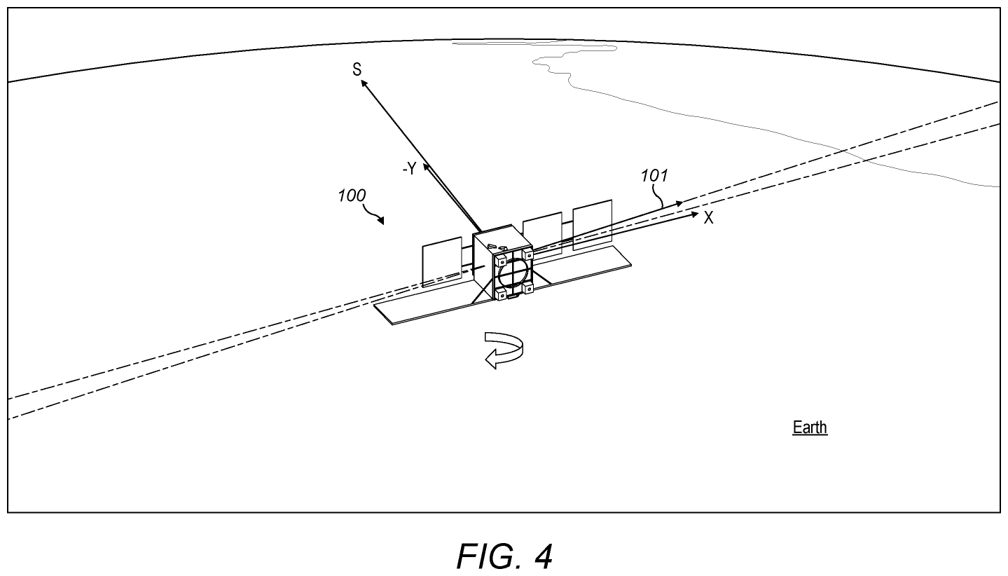

As shown in FIGS. 1 to 5, the satellite 100 is oriented in the first position in which the radiative surface 140 points away from the sun S. In the first position, the radiative surface 140 can emit satellite heat to space. Initially, the ADCS system rotates the satellite 100 counter clockwise around an axis of rotation Z, as indicated by the arrow in FIGS. 1 to 3, to allow the solar panel 150 to be continuously oriented towards the sun. In FIG. 4, the satellite's rotation around the axis of rotation Z is reversed. In other words, the satellite no longer follows the sun to maximize solar power input received via the solar panels 150. FIG. 4 marks the beginning of the so called “sun kick manoeuvre”, in which a change of position from the first position to the second position is initiated.

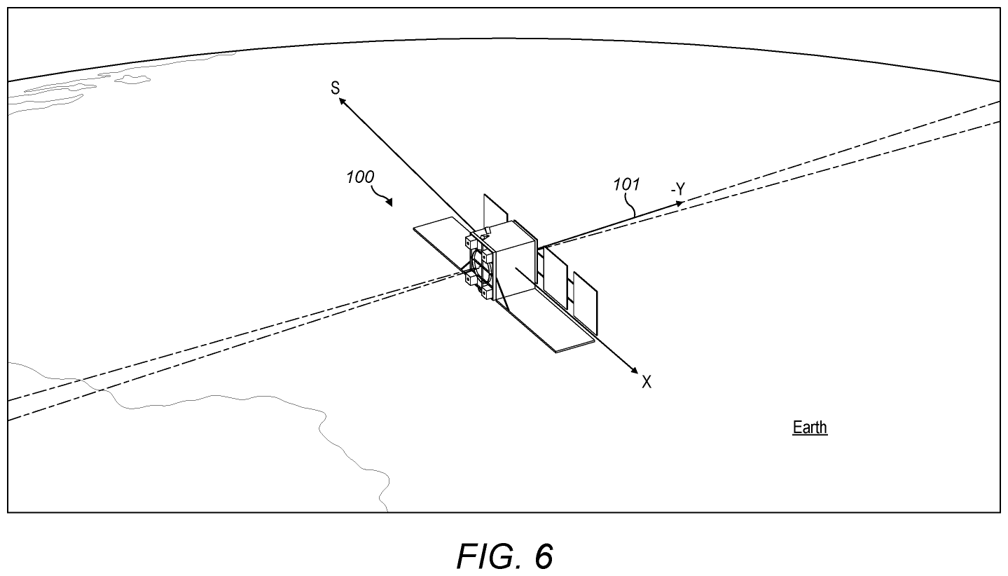

The ADCS system controls the satellite to rotate in a clockwise direction until it reaches the second position in FIG. 6, in which the radiative surface 140 is (at least partially) exposed to the sun S. An angle between the first direction Y and the solar radiation incident on the radiative surface 140 is approximately 90°. In the second position, as shown in FIGS. 6 to 9, the radiative surface absorbs incident heat from solar radiation. The amount of heat that can be absorbed depends on the duration the satellite spends in the second position, the angle between the incident solar radiation and the radiative surface, as well as the size of the radiative surface and its absorptivity properties.

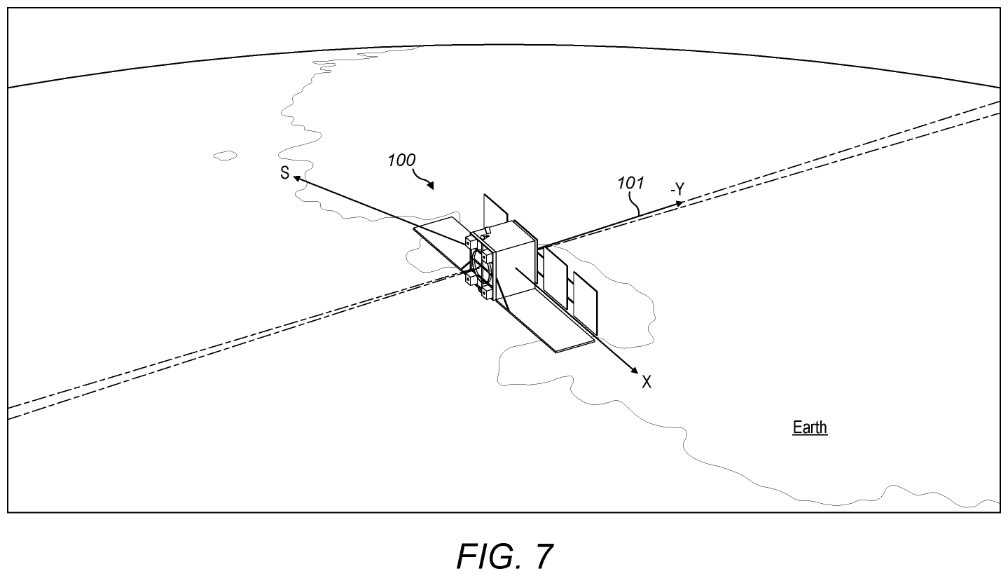

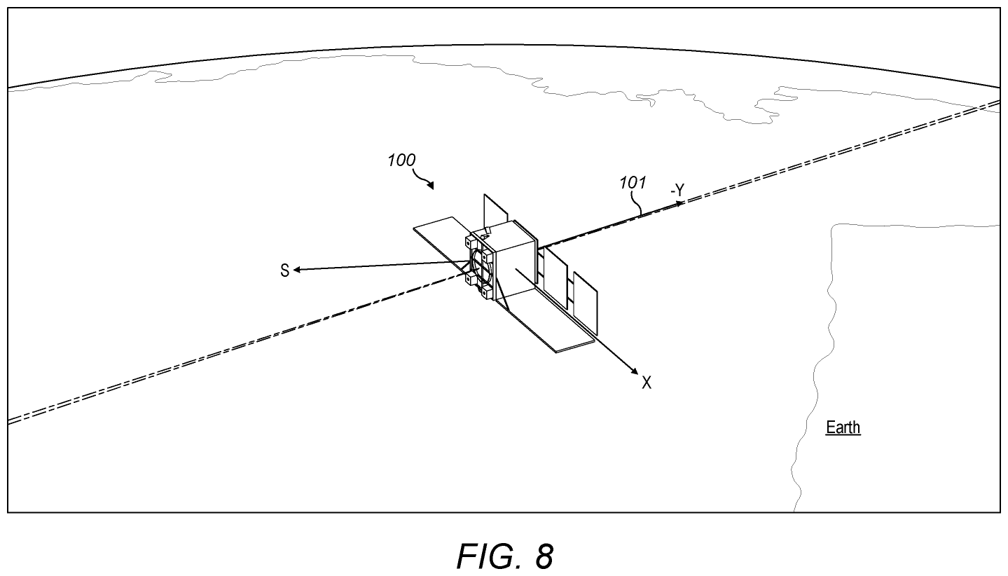

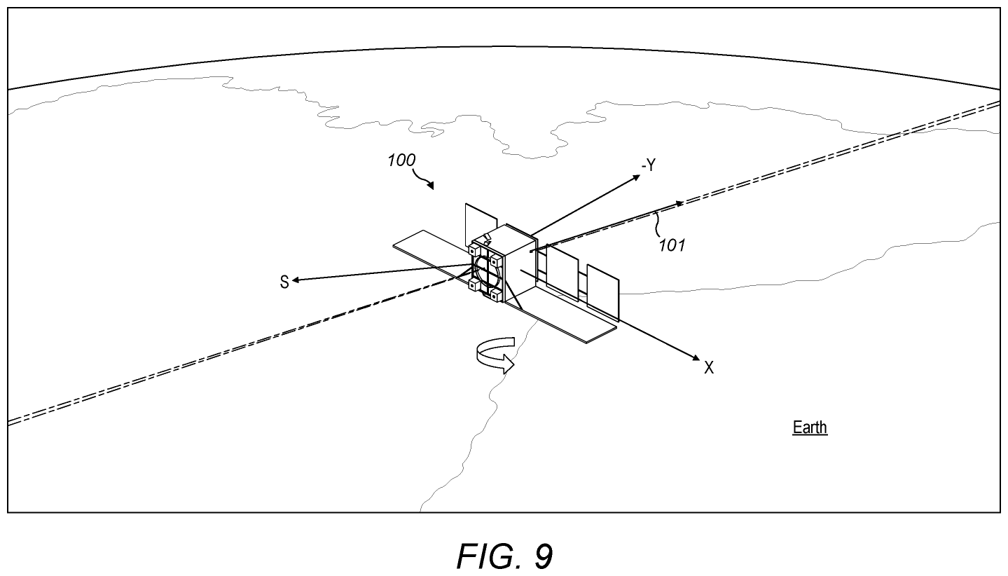

As can be seen in FIGS. 6 to 8, the orientation of the satellite in the second position is maintained. The orientation of the satellite 100 with respect to the sun changes as the satellite travels along the travel direction 101. In FIG. 7, the angle between the first direction Y normal to the radiative surface 140 and the solar radiation incident on the radiative surface is less than 60°. In FIG. 8, the angle between the first direction Y and the solar radiation incident on the radiative surface is less than 30°. In FIG. 9, the satellite 100 is still in the second position but, is controlled to rotate in a counter clockwise direction to reorient the satellite from the second position back to the first position. According to an example, the satellite is maintained in the second position for a total of at least 5 minutes, optionally at least 10 minutes, optionally at least 15 minutes to increase the satellite's temperature by several degrees ° C. The ability of the satellite to control to a certain temperature depends strongly on the time/duration that the satellite is maintained in the second position. By adjusting the duration, which the satellite spends in the second position, the absorbed heat can be controlled with an accuracy down to 1 Watt. Instead of using a fixed duration, it is also possible to use a temperature set point. In one example, the temperature set point is determined by the upper temperature limit of the battery and/or other components of the satellite. For example, if the battery temperature reaches an upper temperature limit, for example 18° C., the satellite is no longer maintained in the second position. In some embodiments, the satellite can be controlled to remain in the second position until a predetermined satellite temperature has been reached.

Maintaining the satellite in the second position allows control of the satellite's temperature by absorption of incident heat from solar radiation received via the radiative surface. This can be described as a heating phase. The received solar power input received via the radiative surface can be controlled based on a predetermined duration, required power input, or desired temperature. Accordingly, a heating function can be implemented that is actively controlled by the ADCS system. Accordingly, a heating function can be implemented without requiring the use of electricity to directly heat up the satellite. The other side of the radiative surface 140 can also be used to radiate the solar power input received towards internal elements to heat them up. The radiative surface 140 can also conduct heat through connecting members to internal elements to heat them up. In an example, the radiative surface 140 is part of a panel that is made of aluminium, which provides for good thermal conductivity.

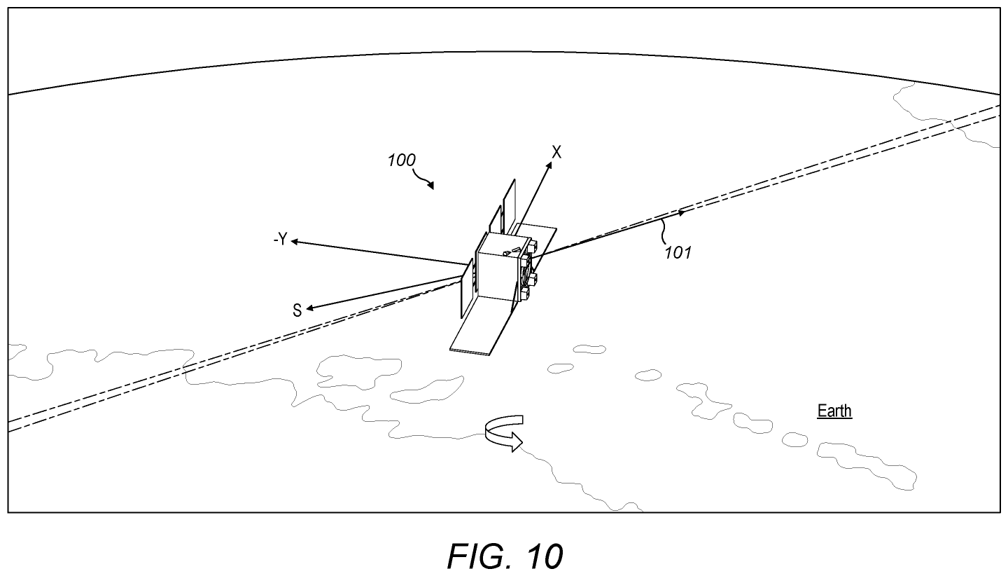

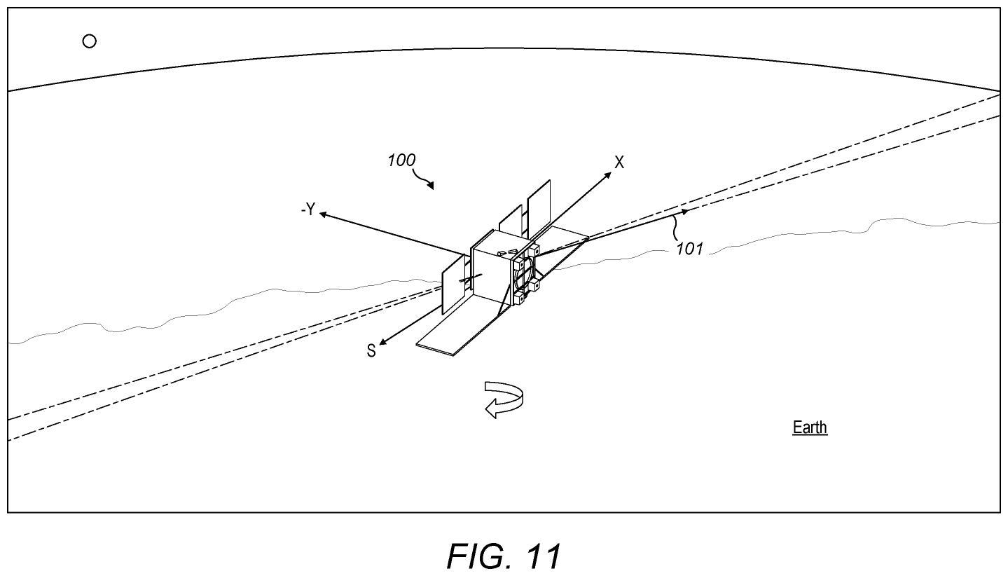

In FIGS. 10 and 11, the satellite 100 is again oriented in the first position, in which the radiative surface 140 is used to emit heat. This can be described as a cooling phase. Maintaining the satellite in the first position allows to control the satellite temperature by emission of satellite heat to space via the radiative surface. Accordingly, a cooling function can be implemented that is actively controlled by the ADCS system. The cooling phase is typically long, as the solar panels are oriented towards the sun as much as possible to provide power to the spacecraft and to charge the battery.

Based on the above described heating and cooling phases and by adjusting the duration of both phases, a thermal control strategy can be designed that allows the average temperature inside the satellite body to remain in an allowable or preferred temperature range. The strategy depends on the size of the radiative surface needed to cool down the satellite during the worst case scenario, and the duration of the satellite in the second position to keep the minimum temperature above an acceptable level. By alternating the orientation of the satellite between the first and second position it is possible to selectively provide for heating and cooling of the satellite, as needed.

The cooling and heating functions depend on the surface optical properties of the radiative surface, namely solar absorptivity and IR emissivity. Solar absorptivity governs how much incident heating from solar radiation a spacecraft absorbs, while IR emissivity determines how much heat a spacecraft emits to space and how much heat is received from Earth. The surface properties of the radiative surface can be modified by adding, for example, an adhesive tape depending on the particular requirements of the satellite. Other methods such as coating or otherwise modifying the surface of the radiative surface are also possible.

The radiative surface may provide a solar absorptivity between 10% and 60%, optionally between 20% and 50%, optionally between 30% and 40%. In this range, the absorbed incident heat from solar radiation received via the radiative surface is enough to control the satellite temperature but not too much to exceed allowable or preferred temperature ranges for components quickly.

Tape can be added later in the assembly process, is easy to apply and relatively inexpensive. In some embodiments, the surface properties of the radiative surface 140 can be modified by adding an adhesive tape such that the surface is configured to be able to both absorb a high percentage of solar heating and emit a high percentage of spacecraft heat. In some embodiments, an adhesive tape comprising a polyvinyl fluoride (PVF) film is applied to the radiative surface. In some embodiments, Tedlar® is used for the PVF film. An example tape including a Tedlar® PVF film backing is 3M™ Weather Resistant Film Tape 838.

Tedlar® PVF film was first used in film form for aircraft interiors, where it was able to meet stringent toxicity and flammability requirements. It was also used early on as highway noise barriers. Tedlar® PVF film has good chemical resistance as well as weathering resistance. The material was not specifically developed for space applications, nor was it developed with a particular absorptivity and emissivity in mind. The datasheet for 3M™ Weather Resistant Film Tape 838 does not list any technical specifications related to absorptivity or emissivity, nor does the datasheet on general properties for Tedlar PVF films. In some examples, the radiative surface, for example comprising Tedlar PVF tape, provides a higher IR emissivity compared to bare aluminium and/or a higher solar absorptivity than bare (polished) aluminium. To this end, the radiative surface may provide an IR emissivity & of at least 0.85, optionally at least 0.9, and/or a solar absorptivity a of at least 0.3, optionally at least 0.35.

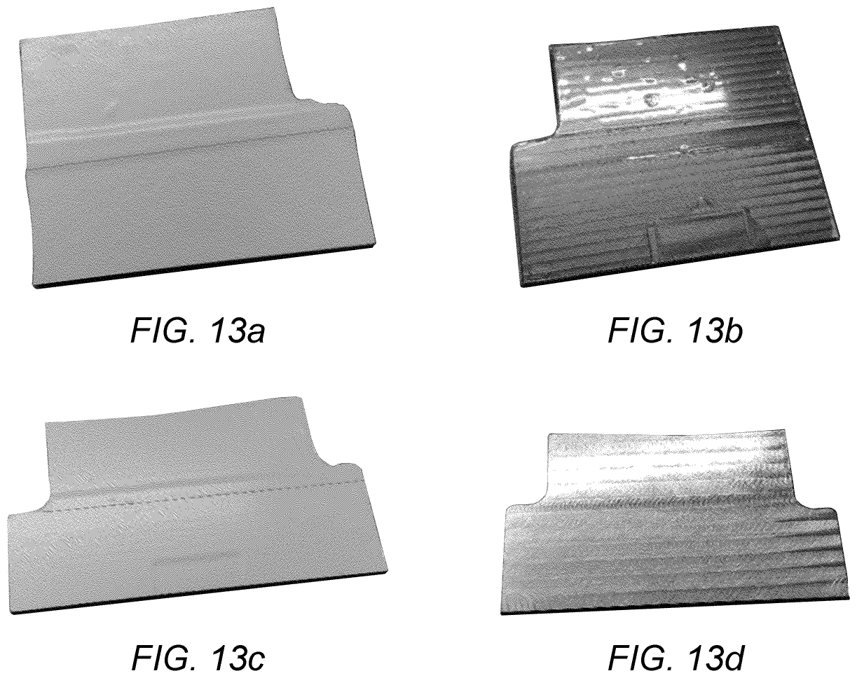

Table 1 shows measured values of absorptivity (a) and emissivity (E) for two samples, which are shown in FIG. 13, based on experiments conducted at a Swiss laboratory. Emissivity and absorptivity have been measured by a dedicated research laboratory using a Perkin Elmer Lambda 900 spectrophotometer equipped with a Spectralon integrating sphere. In the solar wavelength range, the total reflectance is measured between 300 nm and 2500 nm. In the infrared wavelength, the total reflectance is measured between 2.5 μm and 20 μm. Solar reflectance, a, (absorptance or absorptivity) values are calculated from the measurement according to the solar intensity spectrum of ISO 9845 using the solar spectrum for Air Mass Coefficient of 0 outside the atmosphere according to ASTM E 490. The emissivity, (emittance) value is calculated for blackbody radiation at room temperature. The reflectance value for wavelengths longer than 20 micron was extrapolated using a constant value.

Sample 1 has two layers of Tedlar® PVF tape on side 1 (FIG. 13a), which is the side facing the outside of the spacecraft, i.e. the radiative surface. Side 2 (FIG. 13b) is bare polished aluminium with two layers of polyimide film on it. Side 2 faces the inside of the spacecraft. Sample 2 has one layer of Tedlar® PVF tape on side 1 (FIG. 13c) and is bare polished aluminium on side 2 (FIG. 13d). As can be seen from the data, the absorptivity with two layers (α=0.383) and one layer (α=0.377) of PVF film is higher than with the bare polished aluminium sample alone. At the same time, the emissivity of the surface is increased compared to bare aluminium. The emissivity is in fact an order of magnitude higher with the PVF tape on it.

TABLE 1
Absorptivity (α) and Emissivity (ε) of Example Materials

| Sample | Side 1 | Side 1 | Side 2 | Side 2 |
|---|---|---|---|---|
| #: | description: | results: | description: | results: |
| 1 | Aluminium sample | α = 0.383 | Bare polished | α = 0.509 |
| | with 2 layers of | ε = 0.917 | Aluminium with | ε = 0.826 |
| | Tedlar PVF Tape | | 2 layers of | |
| | | | polyimide tape | |
| 2 | Aluminium sample | α = 0.377 | Bare polished | α = 0.263 |
| | with Single layer | ε = 0.897 | aluminium | ε = 0.037 |
| | of Tedlar PVF Tape | | sample | |

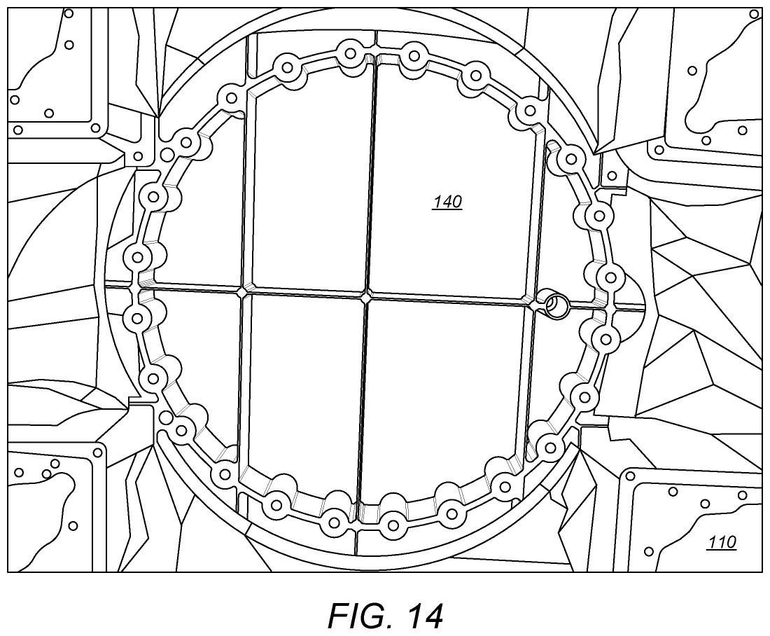

In some embodiments, the radiative surface 140 may be in the form of a structural panel forming part of the existing structure of the satellite body 110, as shown in FIG. 14. This configuration corresponds to the embodiment shown in FIGS. 1 to 11. In this embodiment, the radiative surface 140 has a substantially round shape, and a plurality of mounting holes around its outer circumference. If the radiative surface forms part of the existing structure it can be referred to as a radiative panel. The radiative panel may be an integral part of one side of the satellite. In an example, the radiative panel can even be part of the structure that attaches the satellite to a release mechanism in a rocket as it is being launched into space. The radiative panel can be made of aluminium which has a rather high conductivity. Thus, the temperature is (relatively) uniform on the panel and heat is conducted from one or more component(s) to require cooling to the radiative panel in first position and from the radiative panel to one or more component(s) that require heating in the second position. This is particularly advantageous for small spacecraft due to strict mass constraints. Heat transfers to and from the structure through emission and absorption on the reverse side of the radiative surface as well as through heat conduction through structural members connecting the radiative surface to other parts of the spacecraft.

FIG. 12 is a partial perspective view of a satellite, such as the satellite 100 in FIG. 1. The ADCS 302 is usually located in a satellite body 310, such as the satellite body 110 in FIG. 1, and used to control the orientation of the satellite. The ADCS unit 302 comprises a set of three reaction wheels 370a, 370b, 370c located in the satellite body 310. Reaction wheels are sometimes also known as momentum wheels. The reaction wheels 370a, 370b, 370c can be controlled by the ADCS controller 341. Reaction wheels 370a, 370b, 370c function by using an electric motor to spin a wheel inside the satellite body 310. By conservation of angular moment, spinning the wheel in one direction causes the satellite to rotate in the opposite direction. Using reaction wheels is a well-known way of orienting spacecraft such as satellites. In this example, three reaction wheels 370a, 370b, 370c are provided, one for orienting the satellite in each axis. The reaction wheels 370a, 370b, 370c are shown to have orthogonal axes. In another example, four or more reaction wheels may be used in order to have better control over various aspects of the satellites dynamics, such as slew rate and fine positioning control, particular for satellites with higher moments of inertia.

The ADCS unit shown in FIG. 12 further comprises torque rods 305a, 305b, 305c. Torque rods can also be used in satellites to provide attitude control. The torque rods 305a, 305b, 305c are generally operated to maintain the satellite 300 in a particular attitude, wherein the operation is controlled by the ADCS controller 341, which is explained below.

The ADCS unit 302 further comprises an ADCS controller 341. The ADCS controller 341 is in communication with the on-board computing system 340. The on-board computing system 340 comprises a processor 349, a memory 348 and a telemetry unit 345. The memory 348 can be used to store allowable or preferred temperature ranges for components of the satellite and/or temperature set points. The ADCS controller 341 is further configured to receive information from or more sensors 347. The one or more sensors 347 are configured to measure various quantities during the flight of the satellite, such as sun-sensor, star tracker 170, temperature sensors and/or magnetometer for measuring local magnetic field. The ADCS controller 341 is further in communication with a GPS receiver module comprising a GPS receiver 352 and a GPS antenna 353. The ADCS unit 302 is configured to change the orientation of the satellite with respect to the sun between the first position in which the radiative surface points away from the sun and the second position in which the radiative surface is exposed to the sun for controlling thermal radiation heat transfer of the satellite.

In some embodiments, the satellite may be a micro satellite or a small satellite. The smaller size and greater agility of micro and small satellites facilities them to be manoeuvred in their entirety to change their orientation. This kind of manoeuvre may be performed using the ADCS unit. In an example, satellite 100 may be a micro satellite with a mass of 100 kg. Regular satellites having a mass of approximately 1000 kg are generally more expensive and less agile than micro satellites. Satellites may be categorised according to their mass. For example, a satellite having a mass between approximately 1 kg and approximately 10 kg may be categorised as a cube satellite, a satellite having a mass between approximately 50 kg and approximately 250 kg may be categorised as a micro satellite; a satellite having a mass of approximately 500 kg may be categorised as a small satellite; and a satellite having a mass between approximately 800 kg and approximately 1200 kg may be categorised as a regular satellite.

While larger satellites may provide the opportunity to implement active thermal control, such as electrical resistance heaters, cryocoolers, thermoelectric coolers, or fluid loops, on-board the satellites, it may not be feasible to implement such active thermal control on smaller satellites, such as micro satellites (without adding weight or volume).

In some embodiments, the SAR antenna faces towards Earth in the first and second position. In this implementation the satellite rotates around one axis to change the orientation from the satellite between the first and second positions. SAR antennas may have strict temperature requirements and should experience as little thermal cycling as possible. By maintaining the SAR antenna in an orientation in which it faces Earth, the SAR antenna is in optimal orientation for starting imaging and experiences the smallest possible range of temperatures.

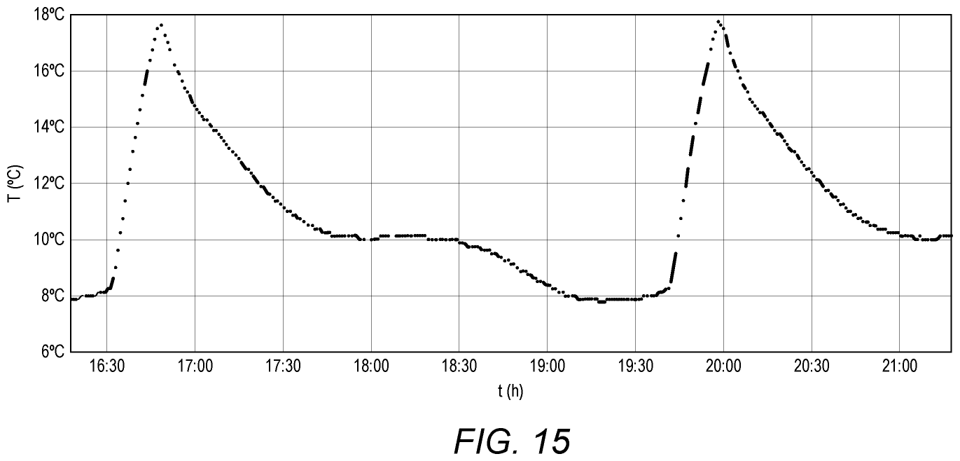

FIG. 15 shows a temperature profile of the radiative surface. The temperature profile has been simulated for a radiator panel forming part of the existing structure of the satellite body 110 wherein the radiative surface 140 is made of an adhesive tape comprising a polyvinyl fluoride film. Between approximately 16:30 and 16:45 as well as between approximately 19:45 and 20:00, the orientation of the satellite is changed to the second position in which the radiative surface is exposed to the sun. As can be seen during these time periods, a temperature T of the radiative surface increases almost linearly with time. During these time periods the temperature increases due to the absorption of incident heat from solar radiation received via the radiative surface. These time periods can be described as heating phase. Between the heating periods, the satellite is oriented to be maintained in the first position, in which the satellite temperature decreases due to emission of satellite heat to space via the radiative surface. This time period can be described as a cooling phase. As can be seen in FIG. 15, the temperature of the radiative surface remains between 8° C. and 18° C. over a period of approximately 5 hours. Accordingly, by controlling the orientation of the satellite to alternate between the first and second position, the radiative surface selectively provides for heating and cooling of the satellite. This provides an active thermal control of the satellite that is controlled by the ADCS system.

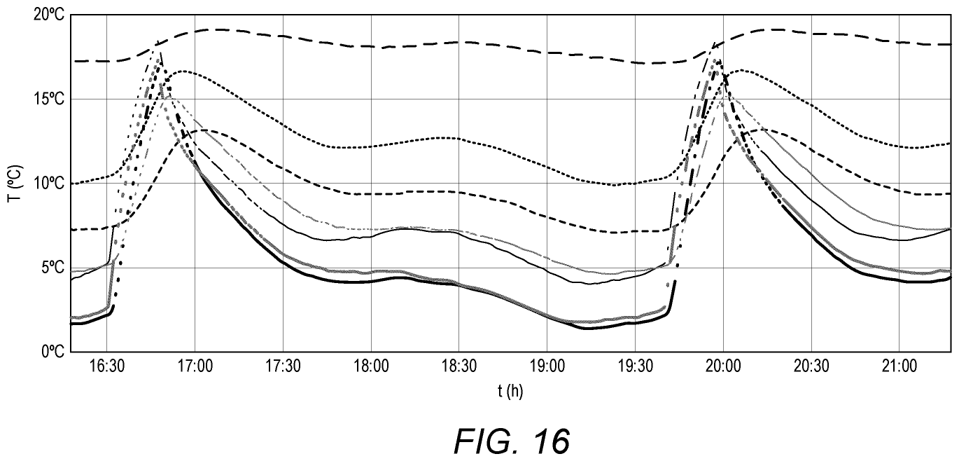

FIG. 16 shows a plurality of temperature profiles of different components on-board the satellite. Similarly to FIG. 15, the temperature control includes two heating phases of approximately 15 minutes each. As can be seen in FIG. 16, the temperature of every component remains between 0° C. and 20° C. over the simulated time period of approximately 5 hours. Accordingly, the solar power input received via the radiative surface is sufficient to meet temperature requirements of a plurality of instruments on-board the satellite. For example, batteries are components that have relatively narrow temperature limits due to their narrow operating range, typically between 0° C. and 20° C. The method of controlling thermal radiation heat transfer can be used to maintain temperature ranges for electronics and batteries in-orbit. By adjusting an incidence angle between the radiative surface and the sun throughout the orbit of the satellite, the exchange of heat can be actively controlled to provide thermal stability for components. By adjusting the duration that the satellite spends in the second position, the absorbed heat can be controlled with an accuracy down to 1 Watt.

The method of controlling thermal radiation heat transfer based on the ADCS unit can provide for the redundant function of a standard thermal control system. Accordingly, the method may replace a redundant line of a thermal control system. Standard thermal control systems do usually comprise two redundant lines of electrical heaters, thermostats and cabling: one being the main line and one redundant. By replacing the redundant line with the method of controlling thermal radiation heat transfer based on the ADCS unit, the number of parts to be integrated into the satellite and thus costs can be reduced. Accordingly, the satellite can be designed with one instead of two redundant electrical heating systems, which may also provide for less power consumption.

For an imaging satellite, the method of controlling thermal radiation heat transfer of the satellite is typically performed when the satellite is not imaging. However, it can be used to complement such tasks. The method of controlling thermal radiation heat transfer can be performed, for example, between imaging tasks to provide for comparable temperature conditions upon start of each imaging task. The method can also be performed during thrust phases to cool down the satellite. During thrusting phase, a power input is generated by the propulsion inside the spacecraft while the attitude of the spacecraft is fixed, which may include solar inputs on the radiative surface (satellite in the second position) that lead to an undesired raise of the satellite's temperature. Between two thrusting phases, the radiative surface is oriented towards space (satellite in the first position) for a predetermined period to evacuate the previously generated heat. The thrust phase duration can thereby be reduced since temperature is not a concern anymore. The method of controlling thermal radiation heat transfer of the satellite can also be implemented for other spacecraft, such as a communication satellite.

Additionally or alternatively, the method may be repeated at a predetermined position in the orbit, at a predetermined time and/or in response to a measured temperature. For example, the satellite can be tasked to change between the first position to the second position during a fixed part of the orbit. The fixed part of the orbit could be during times when the satellite is passing over parts of the Earth where no imaging is desired. The fixed part of the orbit could also be to only change from the first position to the second position when the satellite is not shaded from the sun by the Earth. The method may also be performed based on a measured temperature and a temperature set point for one or more of the components or the radiative surface. Similarly to the embodiment shown in FIGS. 15 and 16, the satellite may be controlled to remain in the first position until a temperature drops below, for example, 8° C., and/or to maintain the satellite in the second position until a temperature exceeds, for example, 18° C. Accordingly, the satellite is maintained in the second position until a (predetermined) temperature set point is reached.

The embodiments described above are fully automatic. In some examples a user or operator of the system may manually instruct some steps of the method to be carried out.

In the described embodiments of the invention the system may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that can be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer.

Although illustrated as a local device it will be appreciated that the computing device may be located remotely and accessed via a network or other communication link.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1. A satellite comprising:
a satellite body including at least one radiative surface configured to emit satellite heat to space; and
an attitude determination and control ‘ADCS’ system for controlling an orientation of the satellite travelling in orbit around Earth, wherein the ADCS system is configured to change the orientation of the satellite with respect to the sun between a first position in which the radiative surface points away from the sun and a second position in which the radiative surface is exposed to the sun.

2. The satellite according to claim 1, wherein the ADCS system is configured to change the orientation of the satellite by rotating the satellite around an axis of rotation (Z) extending substantially perpendicular to a travel direction of the satellite.

3. The satellite according to claim 1 or 2, wherein a surface normal to the radiative surface extends away from the satellite body in a first direction (Y) substantially perpendicular to the axis of rotation (Z).

4. The satellite according to claim 3, wherein, in the second position, an angle between the first direction (Y) and solar radiation incident on the radiative surface is 90° or less, optionally less than 60°, optionally less than 30°, optionally less than 10°.

5. The satellite according to any preceding claim, further comprising one or more temperature sensor(s) for determining a satellite temperature and/or a temperature of one or more components of the satellite, wherein the ADCS system is configured to change the orientation of the satellite in response to a signal from the one or more temperature sensor(s).

6. The satellite according to any preceding claim, wherein the ADCS system is configured to maintain the satellite in the second position to control a satellite temperature by absorption of incident heat from solar radiation received via the radiative surface.

7. The satellite according to claim 6, wherein the ADCS system is configured to maintain the satellite in the second position for at least 5 minutes, optionally at least 10 minutes, optionally at least 15 minutes.

8. The satellite according to claim 6, wherein the ADCS system is configured to maintain the satellite in the second position until a temperature set point has been reached.

9. The satellite according to any preceding claim, wherein the ADCS system is configured to maintain the satellite in the first position to control the satellite temperature by emission of satellite heat to space via the radiative surface.

10. The satellite according to any preceding claim, wherein the radiative surface has a solar absorptivity between 10% and 60%, optionally between 20% and 50%, optionally between 30% and 40%.

11. The satellite according to any preceding claim, wherein the radiative surface provides an infrared ‘IR’ emissivity of at least 0.85, optionally at least 0.9 and a solar absorptivity of at least 0.3, optionally at least 0.35.

12. The satellite according to any preceding claim, wherein the radiative surface covers an area of at least 0.05 m², optionally at least 0.1 m², optionally at least 0.15 m².

13. The satellite according to any preceding claim, wherein the radiative surface comprises part of a radiator panel forming part of an existing structure of the satellite body.

14. The satellite according to any preceding claim, wherein the radiative surface comprises an adhesive tape comprising a polyvinyl fluoride film.

15. The satellite according to any preceding claim, wherein the satellite further comprises one or more solar panel(s) attached to the satellite body, wherein a surface normal to a solar surface of the solar panel(s) extends away from the satellite body in a direction substantially opposite to the first direction (Y).

16. The satellite according to any preceding claim, wherein the ADCS system is configured to control the orientation of the satellite to alternate between the first and second position to selectively provide for heating and cooling of the satellite.

17. The satellite according to any preceding claim, further comprising a SAR antenna attached to the satellite body, wherein the SAR antenna faces towards Earth in the first and second position.

18. The satellite according to any preceding claim, wherein the satellite is a microsatellite, or a small satellite.

19. The satellite according to any preceding claim, wherein the satellite is an imaging satellite for Earth observation, optionally a SAR satellite.

20. A method of controlling thermal radiation heat transfer of a satellite, optionally the satellite according to any preceding claim, wherein the satellite comprises a satellite body including at least one radiative surface configured to emit satellite heat to space, and an attitude determination and control ‘ADCS’ system for controlling an orientation of the satellite travelling in orbit around Earth, wherein the method performed by the ADCS system comprises:
changing the orientation of the satellite with respect to the sun between a first position in which the radiative surface points away from the sun and a second position in which the radiative surface is exposed to the sun.

21. The method according to claim 20, wherein changing the orientation of the satellite includes rotating the satellite around an axis of rotation (Z) extending substantially perpendicular to a travel direction of the satellite.

22. The method according to claim 20 or 21, further including:
maintaining the satellite in the second position to control a satellite temperature by absorption of incident heat from solar radiation received via the radiative surface.

23. The method according to claim 22, further including:
maintaining the satellite in the second position for at least 5 minutes, optionally at least 10 minutes, optionally at least 15 minutes.

24. The method according to claim 22, further including:
maintaining the satellite in the second position until a temperature set point is reached.

25. The method according to any one of claims 20 to 24, further including:
maintaining the satellite in the first position to control the satellite temperature by emission of satellite heat to space via the radiative surface.

26. The method according to any one of claims 20 to 25, further including:
alternating the orientation of the satellite between the first and second position to selectively provide for heating and cooling of the satellite.

27. The method according to any one of claims 20 to 26, wherein the method replaces a redundant line of a thermal control system.

28. The method according to any one of claims 20 to 27, wherein the method is performed between imaging missions.

29. The method according to any one of claims 20 to 28, wherein the method is performed at a predetermined position in the orbit, a predetermined point in time and/or in response to a measured temperature.
